(19) United States
(12) Patent Application Publication
(10) Pub. No.: US 2002/0152077 A1
(43) Pub. Date: Oct. 17, 2002

(54) Sign language translator

(76) Inventor: Randall R. Patterson, Grand Junction, CO (US)

Correspondence Address: CHRISTIE, PARKER & HALE, LLP, 350 WEST COLORADO BOULEVARD, SUITE 500, PASADENA, CA, 91105, US

(21) Appl. No.: 10/121,280

(22) Filed: Apr. 11, 2002

Related U.S. Application Data
(60) Provisional application No. 60/283,669, filed on Apr. 12, 2001.

(51) Int. Cl. G06F 17/28

(52) U.S. Cl. 704/271

(57) ABSTRACT

A method and apparatus for translation of hand positions into symbols. A glove for wearing on an operator's hand includes bend sensors disposed along the operator's thumb and each finger. Additional bend sensors are located between selected fingers and along the wrist. A processor generates a hand position signal using bend sensor signals read from the bend sensors and transmits the hand position signal to an output device. The output device receives the hand position signal and generates a symbol representative of the hand position signal using the received hand position signal and a lookup table of hand position signals associated with a set of symbols. The output device then produces either a visual or audio output using the symbol.

### CROSS-REFERENCE TO RELATED APPLICATION

This application claims priority to and the benefit of U.S. Provisional Application No. 60/283,669 filed Apr. 12, 2001, which is hereby incorporated by reference as if set forth in full herein.

### BACKGROUND OF THE INVENTION

This invention relates generally to the field of translators and specifically to portable sign language translators.

Personal communication skills are vital to a successful life. However, many millions of people suffer from impaired speaking and listening abilities. A significant majority of these people use hand sign language to communicate, such as the American Sign Language, portions of which are depicted in FIG. 1 wherein letters are formed by various hand/finger/thumb/wrist combinations. Although American Sign Language is said to be the fourth most commonly used language in the United States, it is not familiar to many people. It, therefore, becomes very difficult to converse with someone who doesn't know any such sign language. If users of American Sign Language had a device that could readily translate from sign language to written or audible words, the process of communication would become much easier. Therefore, it would be very helpful for people with speaking disabilities to have, in particular, an American Sign Language interpreter device to translate their finger spelling into readable text or audible speech. Accordingly, what is needed is a simple, cost-effective, hardware/software system to translate the American Sign Language alphabet to text characters which are displayed visibly for reading or audibly for hearing. The present invention provides such a system.

### SUMMARY OF THE INVENTION

A method and apparatus for translation of hand positions into symbols is provided. A glove for wearing on an operator's hand includes bend sensors disposed along the operator's thumb and each finger. Additional bend sensors are located between selected fingers and along the wrist. A processor generates a hand position signal using bend sensor signals read from the bend sensors and transmits the hand position signal to an output device. The output device receives the hand position signal and generates a symbol representative of the hand position signal using the received hand position signal and a lookup table of hand position signals associated with a set of symbols. The output device then produces either a visual or audio output using the symbol.

In accordance with the present invention a sign language sensor is provided. The sign language sensor generates a hand position signal in response to a hand position. The hand position signal is transmitted by a transmit subsystem to a remote receive subsystem. A transmitted hand position signal is received by the remote receive subsystem. A plurality of symbols, each symbol associated with a reference hand position signal, is stored in memory. A comparison signal representative of a symbol is generated by matching the transmitted hand position signal to a reference hand position signal associated with the symbol. The comparison signal is processed for output of the symbol as represented by the hand position.

In accordance with an aspect of the present invention, a plurality of voltage dividing sensors are adapted for mounting on a hand, each voltage dividing sensor being driven by a voltage source and providing a respective sensor signal in response to a hand position, each sensor signal being combined to form the hand position signal. A stored reference hand position signal includes reference sensor signals corresponding to the sensor signals in the hand position signal. The plurality of voltage dividing sensors are adapted for mounting along selected finger, palm, wrist and finger gaps of the hand. The voltage dividing sensors are each a flexible sensor whose resistance value changes when bent.

In accordance with another aspect of the present invention, the transmitting of the hand position signal to a remote receive subsystem includes converting the hand position signal from an analog hand position signal to a digital hand position signal and radio frequency transmitting the digital hand position signal.

In accordance with still another aspect of the present invention, the storing in memory of the plurality of symbols associated with reference hand position signals includes determining a reference hand position signal representative of a particular user hand position, the user hand position being formed by the particular user in response to a training symbol and storing in the memory the reference hand position signal associated with the training symbol.

In accordance with still another aspect of the present invention, the hand position signal is matched to a reference hand position signal includes by generating a difference window for each reference hand position signal using the sensor signals in the hand position signal and the corresponding reference sensor signals in the reference hand position signal and selecting as a match the reference hand position signal having a smallest difference window. The difference window can be generated from differences in values between the sensor signals and the corresponding reference sensor signals. The difference window can also generated from summing the differences in values between the sensor signals and the corresponding reference sensor signals. The difference window can also be generated from summing the differences in values between the sensor signals and the corresponding reference sensor signals raised to a specified power.

In accordance with another aspect of the present invention, the hand position signal can be matched to a reference hand position signal by generating a plurality of translation symbols and corresponding precision values for a series of hand position signals and selecting a translation symbol using the plurality of translation symbols and corresponding precision values. A translation symbol can be selected from the plurality of translation symbols having a local maximum in precision as determined from the plurality of precision values. A translation symbol can be selected whose corresponding precision value exceeds a specified threshold.

In accordance with still a further aspect of the present invention, the processing of the comparison signal for output of the symbol that the hand position represents can include visually displaying the symbol on a display device. The display device can be a liquid crystal display. Also, the processing of the comparison signal for display of the symbol that the hand position represents can include converting the comparison signal to an audible sound representative of the symbol.

In accordance with the present invention, each symbol can be selected from alphabet letters, punctuation, symbols and phrases and the remote receive subsystem can be portable, including handheld or wearable.

### BRIEF DESCRIPTION OF THE DRAWINGS

These and other features, aspects, and advantages of the present invention will become better understood with regard to the following description, appended claims, and accompanying drawings where:

FIG. 1 is a depiction of an alphabet as represented in American Sign Language;

FIG. 2 is a block diagram of a sign language translator system in accordance with an exemplary embodiment of the present invention;

FIG. 3A to FIG. 3E are an overview of a sensor subsystem mounted on a glove in accordance with an exemplary embodiment of the present invention;

FIG. 4A and FIG. 4B are electrical schematics of a transmit subsystem in accordance with an exemplary embodiment of the present invention;

FIG. 5A and FIG. 5B are electrical schematics of a receive subsystem in accordance with an exemplary embodiment of the present invention;

FIG. 6A and FIG. 6B are electrical schematics of a receive subsystem coupled to a computer in accordance with an exemplary embodiment of the present invention;

FIG. 7 is a block diagram depicting signal processing stages of a sign language translator in accordance with an exemplary embodiment of the present invention;

FIG. 8 is a process flow diagram of a translation process as used by a sign language translator in accordance with an exemplary embodiment of the present invention;

FIG. 9 is a flow diagram of a comparison process as used by a sign language translator in accordance with an exemplary embodiment of the present invention;

FIG. 10 is a flow diagram of a comparison process as used by a sign language translator in accordance with another exemplary embodiment of the present invention;

FIG. 11 is a graph of translation precision for specific symbols for a sign language translator in accordance with an exemplary embodiment of the present invention;

FIG. 12 is a table of pinouts for a microcontroller as used in a sign language translator in accordance with the present invention.

### DETAILED DESCRIPTION OF THE INVENTION

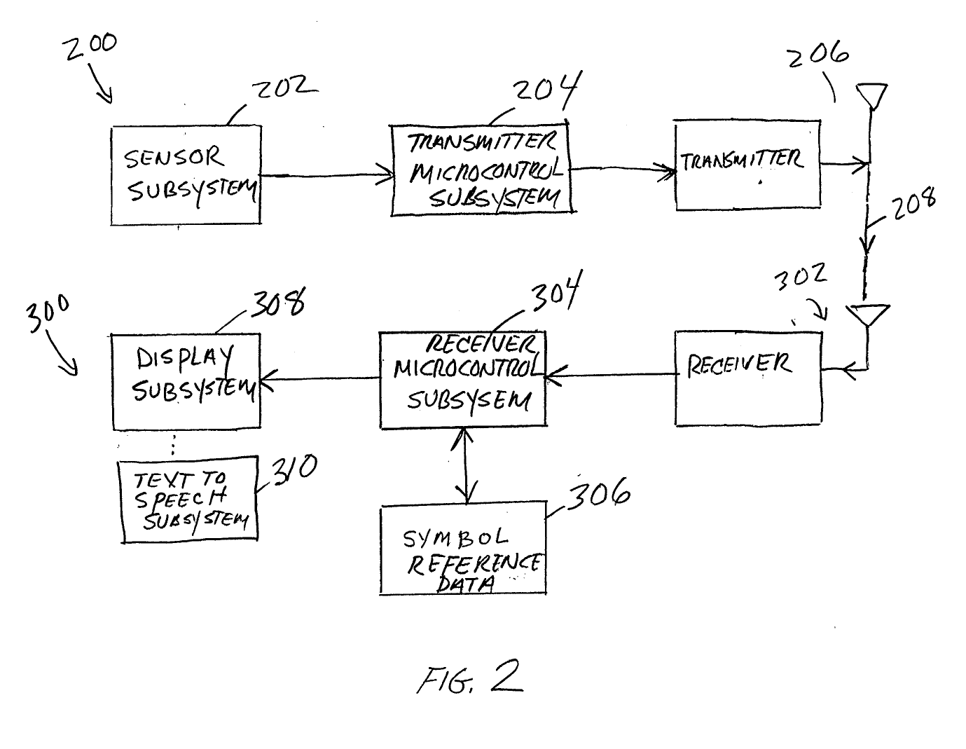

Referring now to FIG. 2, an overview of the sign language translator system is shown. The sign language translator system includes transmit subsystem 200 and receive subsystem 300. Transmit subsystem includes sensor subsystem 202, transmitter microcontrol subsystem 204 and transmitter/antenna 206. Transmit subsystem 200 transmits data over channel 208, e.g. airwaves to receive subsystem 300. Receive subsystem 300 includes receiver/antenna 302, receiver microcontrol subsystem 304 coupled to symbol reference data memory subsystem 306, display subsystem 308, and/or text to speech subsystem 310.

In essence, in accordance with the present invention the transmit portion includes a sensor subsystem having a plurality of sensors mounted on a glove worn on a hand, whose sensed data is processed and communicated to the receive subsystem which has a translate processor and display unit. The glove utilizes a plurality of strain gauges situated in various locations along the hand/wrist. The strain gauges provide voltage data which is read by a microcontroller. The sensed data is then transmitted over an RF link. A portable translator/receiver device, receives the transmitted sensed data and uses mathematical analysis to translate the hand sign data to a symbol, which is can then be printed to the display or audibly spoken through a speaker.

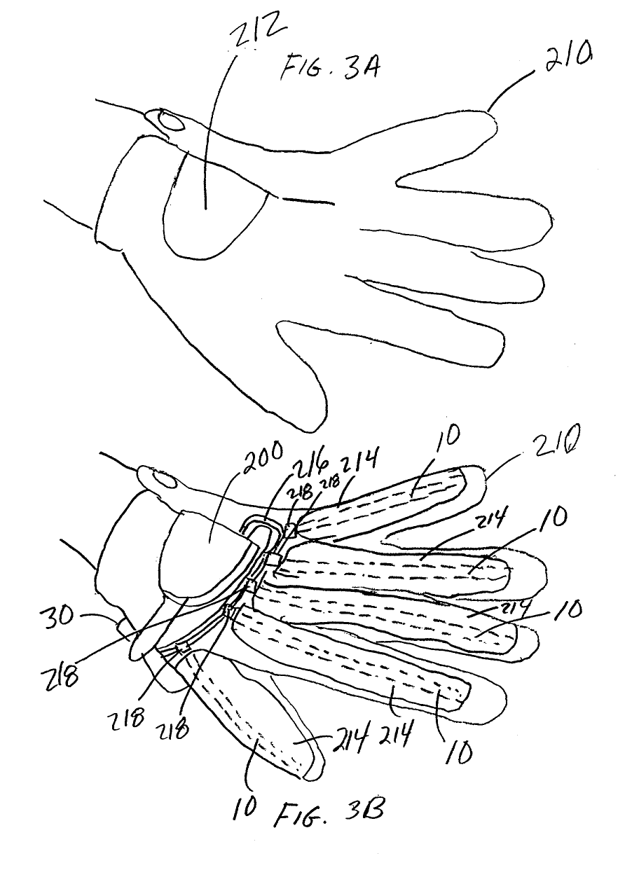

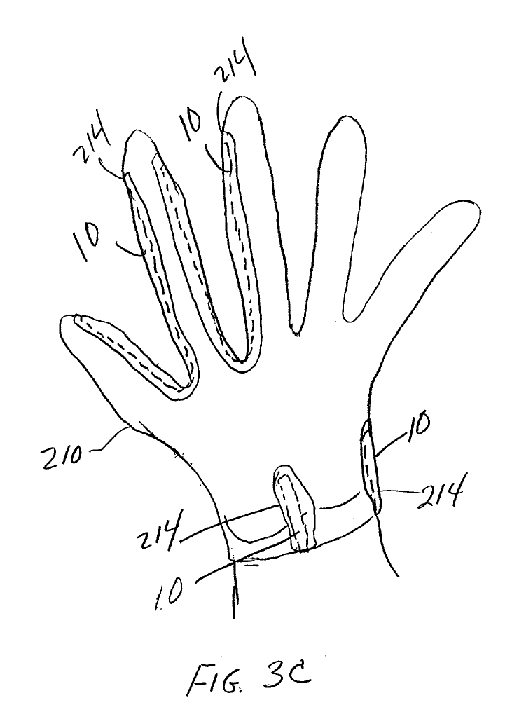

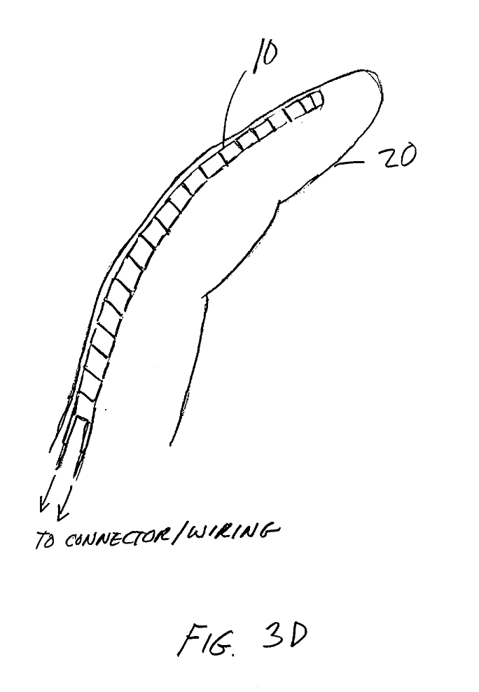

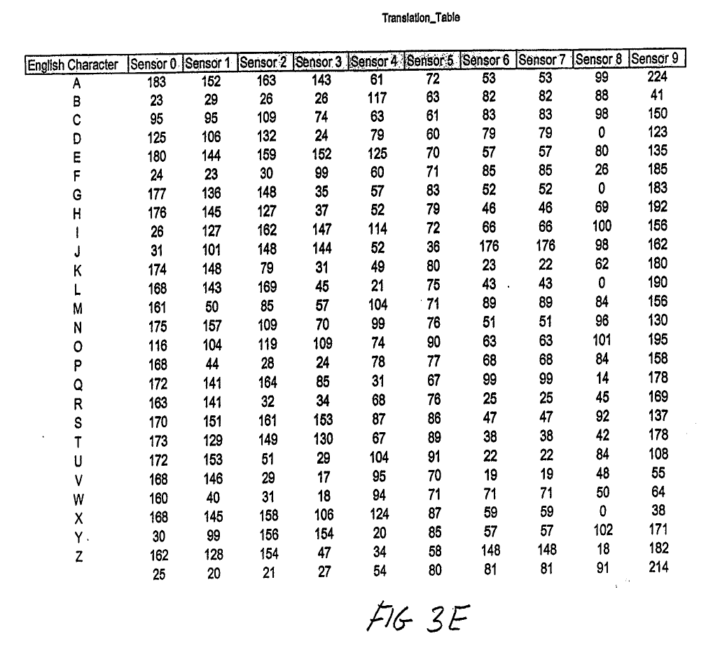

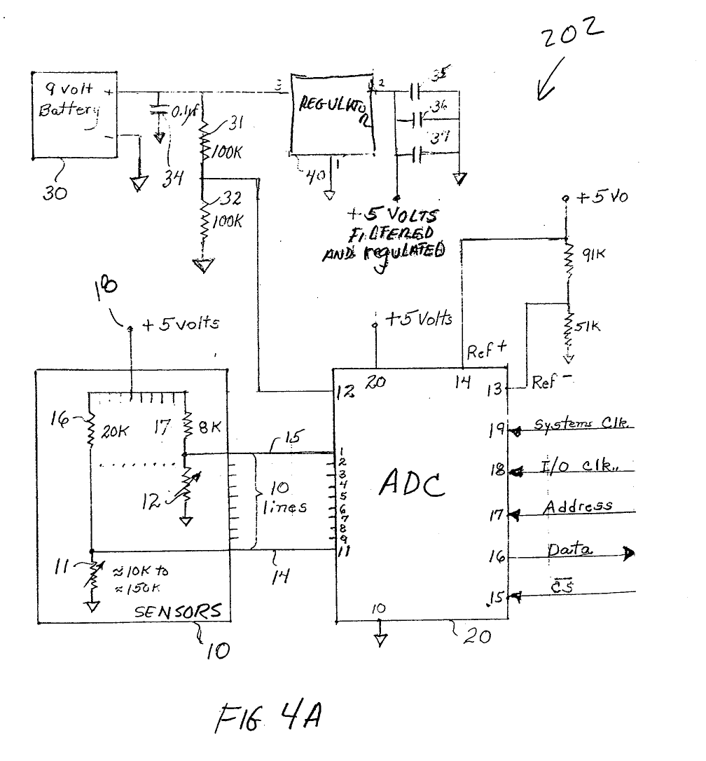

Referring now to FIGS. 3A-3E, an overview of the sensor subsystem mounted on a glove is shown. In FIG. 3A typical golf glove 210 is shown worn on a left hand. Golf glove 210 typically includes velcro flap 212 which secures the glove on the hand. In FIGS. 3B and 3C, golf glove 210 is shown modified to include transmit subsystem 200 mounted thereon via a circuit board. The circuit board is shaped and applied to the outer side of a closed velcro flap 212 by sewing or other attachment technique. A plurality of sensors 10 (shown in dotted lines)are located on the glove supported by pockets sleeves 214 sewn to the glove. Each of the sensors 10 are coupled though wiring harness 216 and connectors 218 to transmit subsystem 200. Battery 30 is also mounted on the glove and coupled through a portion of the wiring harness to both sensors 10 and to transmit subsystem 200. The specific wiring connections for the components are described and shown hereinafter in conjunction with the figures depicting the circuit diagrams.

The sign language translation system in essence consists of two devices: a glove, which is worn by the user to gesture their hand signs, and a portable display unit, which displays translated text representative of the gestured hand signs in large characters for another person to read or which audibly converts the translated text into audible speech. Since many people use different syntaxes of the alphabet, and everybody has a different size and shape of hand, the device is “trained” to each user, much like voice recognition. The user will wear the glove, and sign characters, commands, and phrases. The device will then “learn” how the user signs, so that it can suit itself best to the user's habits.

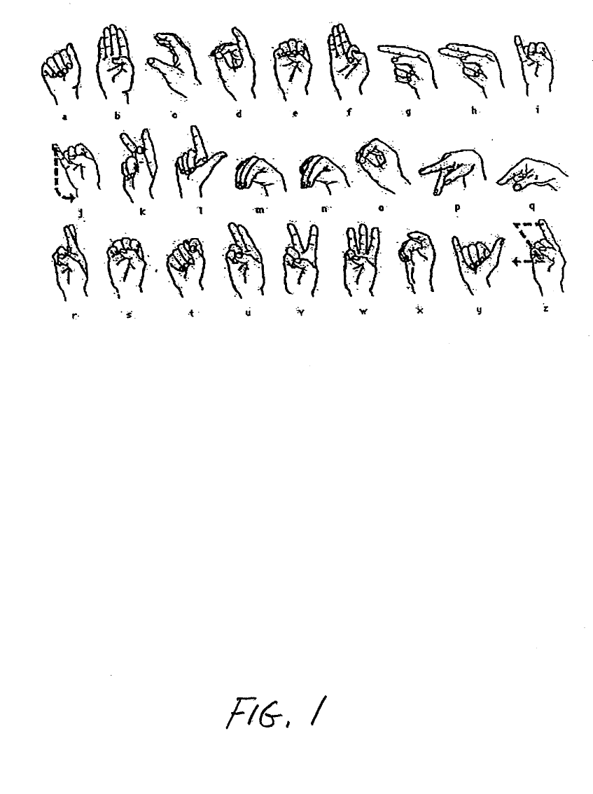

Sensors 10 which are mounted on golf glove 210 include strain gauges that change their resistance as they are flexed, such as those manufactured by Abrams/Gentile Entertainment and described in U.S. Pat. No. 5,085,785. While Virtual Reality (VR) gloves, such as those manufactured by Essential Reality LLC for computer gaming typically have multiple sensors, such VR gloves and their sensors are not suitable to be used to form in combination alphabetical characters. Accordingly, based upon the chart of the American Sign Language alphabet shown in FIG. 1, nine sensors 10 placed on the glove are adequate to track hand movement. As seen in FIGS. 3B an 3C, a full-length sensor is placed on top of the five fingers, and a half-length sensor is placed on the bottom of the wrist, on the side of the wrist, and between the thumb/index finger and the index finger/middle finger. As the hand is moved, the resistance of these sensors ranges anywhere between 14k ohms and 80k ohms, depending on the bend of the particular strain gauge. The reading from the sensors provides analog output voltages to be converted to a digital number representing their positions by digital microcontrollers typically used in communications and math processing. To convert the sensor reading to a digital signal, a voltage divider and analog to digital converter, such as a TLC5411 11-channel 8-bit ADC manufactured by Texas Instruments, are used. The sensors act as one leg of the voltage divider, so there are nine resistors on board the glove's circuit board, to act as the other leg of the voltage divider. The resulting analog voltage is then read by an analog to digital converter, which, in turn, is read by a microcontroller onboard the glove. FIG. 3D depicts in simplified form one of the flex-jointed strain gauges forming a finger sensor (with the mounting sleeve which covers it not shown).

Referring to FIG. 3E, there is depicted a translation table showing for each sensor a relative voltage output, the combination of which will represent an English character. Signs can be specially developed and added to the table for punctuation, spaces between words, etc. to supplement that of the standard American Sign Language. The pausing of finger movement commands the printing of the character. As described above, these analog voltages developed by the user's hand sign depicted are converted to a 8 bit digital voltage sample signals by the analog to digital converter. The resulting digital voltage sample signals are read by a microcontroller and are transmitted to a computing processor which determines the character represented by the voltage sample signal. The determined character can then be visually or audibly displayed by further processing as will be discussed below.

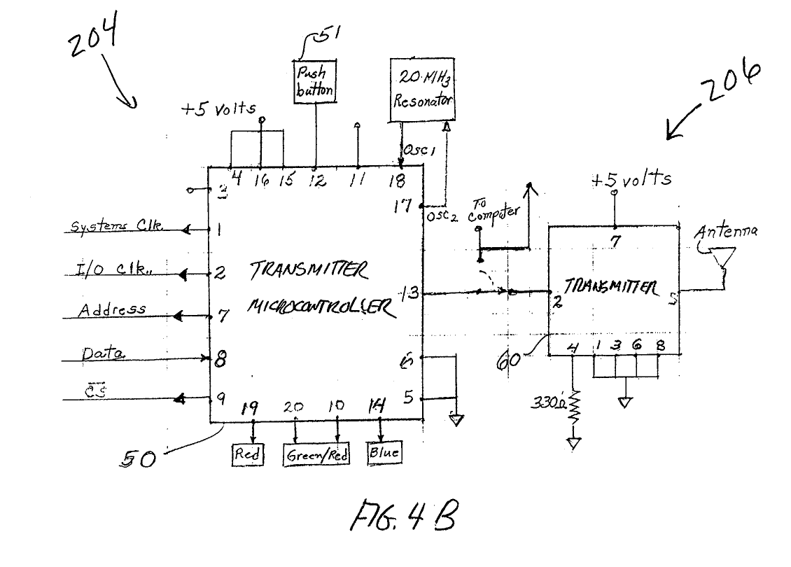

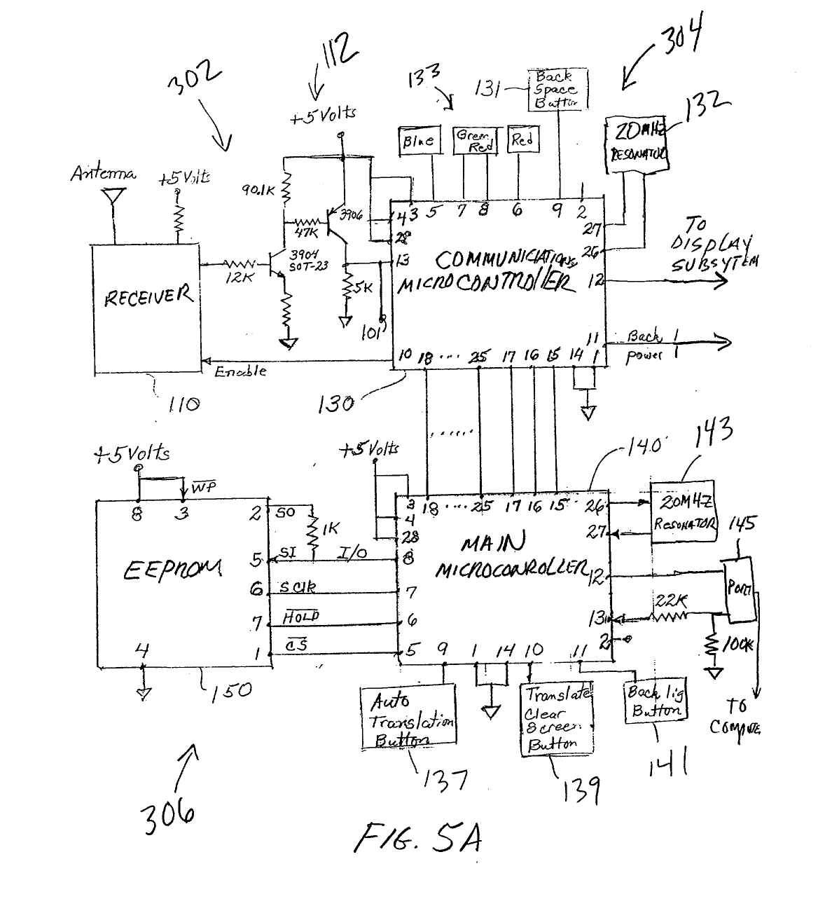

Turning now to FIGS. 4A and 4B, transmit subsystem 200, including sensor subsystem 202, transmitter microcontrol subsystem 204 and transmitter/antenna 206 are now shown in more detail. In FIG. 4A sensors 10 are represented schematically by box 10. There are nine sensors for sensing the position of the hand to sign a particular letter of the alphabet. As the sensors flex they change resistance from a straight position (18K ohms) to a 180 degree bend (80K ohms). A voltage divider is formed generating a voltage in the range of between 2 and 5 volts. The output of the voltage divider is input into a 8 bit analog to digital (A-D) converter. There are eleven channels, nine used for the sensors and one used to monitor its battery level. The nine sensors are representatively shown in FIG. 4A by variable resistors 11 and 12. There is a line from each sensor, such as line 14 from sensor 11 and line 15 from sensor 12. The nine lines from the sensors are the input to A-D converter 20, such as a TLC541FN manufactured by Texas Instruments. This A-D converter has eleven input terminals, nine of which receive the input signals from the sensors. The eleventh input terminal (pin 12) is coupled to battery 30 on glove 210 for monitoring the battery voltage. The input/output pins of the A-D converter 20 are shown on the block 20 of FIG. 4A. Battery 30, which may be a 9-volt battery, is attached to a voltage divider made up of resistors 31 and 32, and a capacitor 34 to provide an output to pin 12 of A-D converter 20. The output of the battery 30 is also an input to a voltage divider and voltage regulator 40, such as a Burr Brown REG1117-5 regulator. The 5-volt output of regulator 40 is filtered by capacitors 35, 36 and 37 connected in parallel between the output of regulator 40 and ground. This regulated 5 volts is applied to the nine sensors 10, A-D converter 20, transmitter microcontroller 50 and transmitter 60.

Sensors 10 include nine different resistance values which power divide a +5 volt source based upon the position of the hand to generate the data corresponding to the alphabet character represented by the voltages provided by the respective sensors. The voltages from the nine sensors are fed as parallel input into analog-digital converter 20. Five communication lines tie ADC 20 to transmitter microcontroller 50. The A-D converter has parallel inputs and a synchronous serial output, with the serial data output being on pin 16 of A-D converter 20 and applied to pin 8 of transmitter microcontroller 50. The channel to be read is addressed by an address sent from transmitter microcontroller 50, which appears on pin 7 and is coupled to pin 17 of the A-D converter 20. As transmitter microcontroller 50 outputs addresses it inputs data from the previous address sent to ADC 20, with the I/O clock from transmitter microcontroller 50 synchronizing communications.

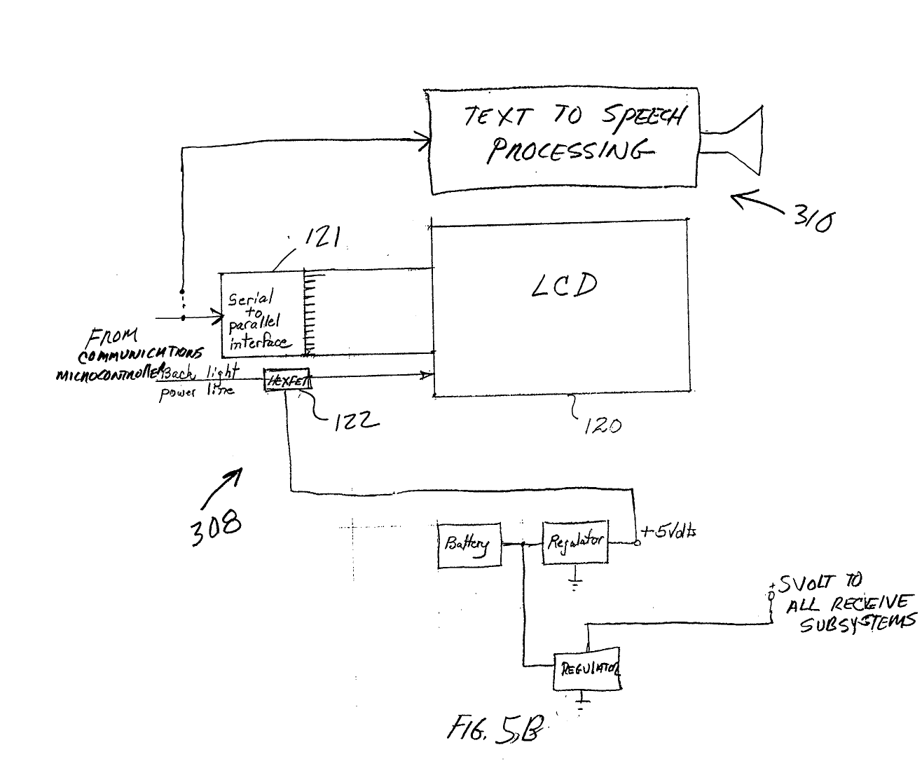

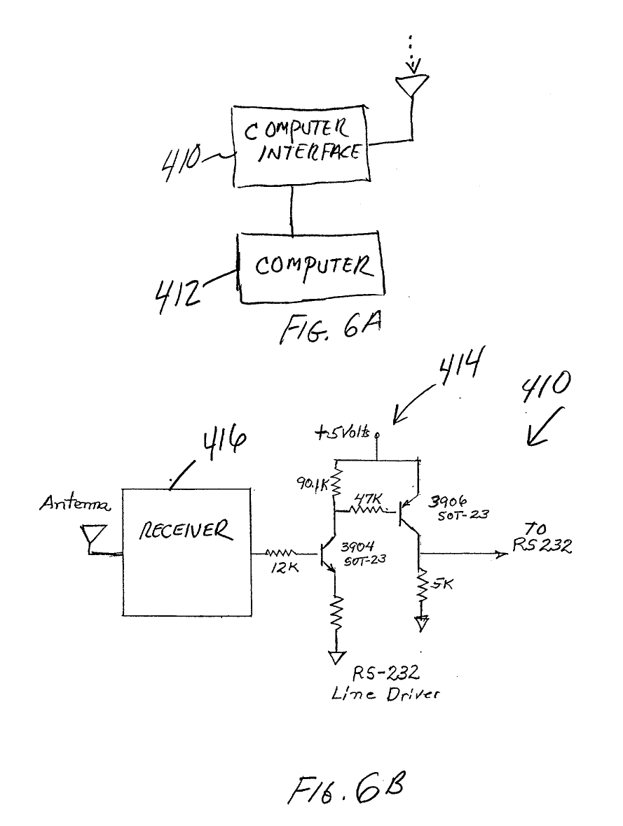

The operation of A-D converter 20 is synchronized with the operation of transmitter microcontroller 50 by an input/output clock that appears at pin 2 of transmitter microcontroller 50 and is coupled to pin 18 of A-D converter 20. A system clock is coupled from transmitter microcontroller 50 on pin 1 to pin 19 of the A-D converter 20. The chip select signal for the A-D converter 20 comes from transmitter microcontroller 50 and appears on pin 9 of transmitter microcontroller 50 and is coupled to pin 15 of the A-D converter 20. Transmitter microcontroller 50 transfers the input signal that was received from the A-D converter 20 to a serial transmit pin 13 for transmission to either a computer, such as a personal computer as shown and discussed below in conjunction with FIGS. 6A and 6B. or the translator and display circuitry of FIGS. 5A and 5B.

Sensor 10 with its nine bend sensors has nine outlet lines, coupled to the A-D converter 20 on the glove of the hand of the user. As the user forms the sign for a particular letter, voltages appear at the output of the lines represented by lines 14 and 15. A resistor 16 if placed in series with the sensor 11 and a resistor 17 is placed in series with the sensor 12. Similar resistors are in series with the other variable resistance bend sensors. The resistors act as a voltage divider to reduce the 5-volt voltage from the source applied at terminal 18 to a voltage between approximately 1.8 volts and 4.5 volts at the output of the sensors. This voltage is applied to the input pins I through 9 and pin 11 of the A-D converter 20. The A-D converter 20 converts the nine voltages to a binary number between 0 and 255. The binary number of all O's at the output of the A-D converter 20 represents all fingers and wrists in the relaxed position so that the sensors are reading the voltage representative of this relaxed position. An output of all l's from the A-D converter 20 represents the position of the hand with all fingers and wrists in the fully bent position to give the maximum voltage output on all nine lines of the sensors on the glove.

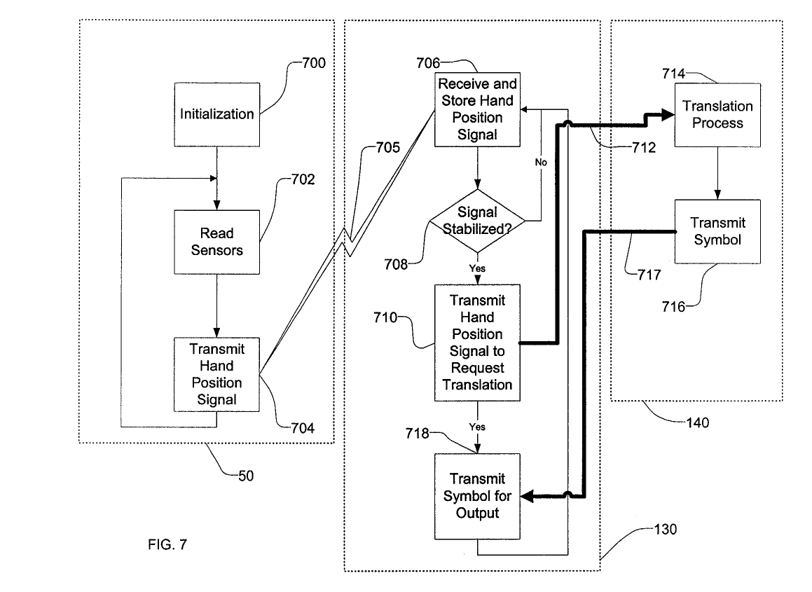

Referring to FIG. 4B, transmitter microcontroller 50 controls the timing of the sensor and signal processing of transmit subsystem 200. Transmitter microcontroller 50 sends address signals from its pin 7 to pin 17 of the A-D converter 20 to select the channel to be read and the output transferred from the A-D converter 20 to transmitter microcontroller 50. The operation of transmitter microcontroller 50 and A-D converter 20 are synchronized by an input/output clock from transmitter microcontroller 50 which appears on pin 2 of the microcontroller and is sent to pin 18 of A-D converter 20. The data from the A-D converter 20 is transferred from its pin 16 to pin 8 of transmitter microcontroller 50. This data is timed in transmitter microcontroller 50 to follow an identification byte that appears on pin 13 of transmitter microcontroller 50. This is represented by byte 1 on FIG. 7 of the communication protocol. Byte 1 is followed by the data that has been sensed from each sensor 0 through 9 and also includes data representing all readings, a battery reading, a push button pressed, or initialization. Push button 51 that has an input at pin 12 of transmitter microcontroller 50 is used in first setting up a system for a new user of the system who may 15 have slightly different finger positions for each letter of the alphabet, and is also used when teaching a new user how to position the fingers and hand for a particular letter of the alphabet. The output of transmitter microcontroller 50 is coupled over the airwaves to an antenna and receiver in the translator and display circuitry of receive subsystem 300. When the data is transferred over the airwaves, it is applied at the output of transmitter microcontroller 50 to transmitter 60 for modulation and transmission. Transmitter 60 can be a TXM-418-LC module. Data between the transmit portion and receive portion is transmitted using basic RS232 communications running at 4800 bits per second, one stop bit, no parity. A 330 ohm resistor coupled to transmitter 60 controls power transmission. The output on pin 13 of transmitter microcontroller 50 is coupled to transmitter or transmitter 60 unless a direct line, e.g., cable, is connected between pin 13 and the circuitry of receive subsystem 300. When such a cable is used, transmitter 60 is disabled. Transmitter microcontroller 50 employs a standard RS232 4800 bits/sec UART coupled to transmitter 60.

The range of voltages at the output of the sensor 10 from the sensors on the hand of 1.8 volts to 4.5 volts is not to be limiting, but is only representative of a voltage range that works effectively with transmit subsystem 200. The real time clock counter (RTCC) pin 3 of transmitter microcontroller 50 is not needed because the timing is done in software and, consequently, this pin is not connected but is left floating. Pin 4, which is designated MCLR is tied to a plus 5 voltage and is held high. Pins 10, 14, 19 and 20 of transmitter microcontroller 50 are coupled to light-emitting diodes with selected colors for diagnostic purposes and to show that the system is operating properly. Pin 11 of transmitter microcontroller 50 is for serial reception and may be connected to the computer for communicating or transferring information from the computer to transmitter microcontroller 50. A 20 Mhz resonator is provided to drive its processor clock.

Turning now to FIGS. 5A and 5B, receive subsystem 300, including receive/antenna 302, receiver microcontroller subsystem 304, character reference data memory 306, display subsystem 308 and text to speech subsystem 310, are shown in more detail. The receive subsystem may be carried on the body of the user, either in a free hand or attached to the clothing, or suspended from some part of the body, for example, of the user. The receiver subsystem /translator includes two microcontrollers, namely communications microcontroller 130 and main microcontroller 140. Communications microcontroller 130 controls the RF receiver, decode data packets and CRC, determines when a translation should occur, controls the LCD back light switching, and reads pushbuttons. Main microcontroller 140 is interfaced to communications microcontroller 130 using an 8-bit bus. Main microcontroller 140 is responsible for actual translations, control of the onboard character reference data memory EEPROM 150, receiving data from the host PC for training, and reading pushbuttons. Both microcontrollers run at 20 MHz keeping power consumption at a minimum.

The sensors continually transmits data. Receive subsystem 300 continually receives the transmitted data. The two microcontroller processors are on board a portable device. Communications microcontroller 130 receives the incoming data and stores in a first set of high speed CPU registers the data from the nine sensors. As a next set of data is received from the nine sensors it is stored in a next set of high speed CPU registers. The sets of data are compared and if there is very little change between the sets of data, it indicates that the position of the hand has minimally changed between data transmissions, e.g. a pause of about 200m sec. The data in the next set of registers gets then moved into the first set of registers, the previous data in the first set having been discarded. The nine sensor data readings then get moved from communications microcontroller 130 into main microcontroller 140. Main microcontroller 140, using a windowing algorithm, starts reading characters from the EEPROM, e.g., A through Z, and makes a probability determination as to the character which the data received by main microcontroller 140 most closely represents. The data for the closest probability determined is held onto and be returned to communications microcontroller 130. Communications microcontroller 130 then sends the data for display printing on the display screen, or, in turn, if applicable, for text to speech vocalizing.

On a personal computer, a user-trained alphabet is stored in a database, for the computer to access when executing a translation. The receive subsystem/portable translator has this data onboard to do translations stored in character reference data memory 306, utilizing an EEPROM, such as the Microchip 25LC640 64 kilobit EEPROM. These devices are electrically erasable so that the user can re-train the device. They retain their data while powered off, and even though writing to an EEPROM can be slow, reading the data back is much faster. Communications thereto is through a high-speed synchronous Serial Peripheral Interface (SPI) compatible serial bus.

Receive subsystem 302 includes RF receiver 110, such as an RXM-418-LS receiver. Voltage boosting transistor circuit 112 is coupled between receiver 110 and communications microcontroller 130 to allow communications microcontroller 130 the ability to read the received data. Voltage boosting transistor circuit 112 boosts the voltage to a 0-5 volt level to allow microcontroller to read the data. Communications microcontroller 130 can be a Scenix SX28AC/SS 8-bit microcontroller in a 28-pin SSOP package. Communications microcontroller 130 controls communication between receiver 110, main microcontroller 140 and display 120. Of note is that communications microcontroller 130 observes the signals representative of lack of hand movement and indicates to main microcontroller 140 that a comparison and print/display operation should be performed.

Main microcontroller 140 is shown below communications microcontroller 130 in FIG. 5A. Main microcontroller 140 can also be a Scenix SX28AC/SS 8-bit microcontroller in a 28-pin SSOP package. Main microcontroller 140 is coupled to EEPROM 150, which contains the translation table for the letters of the alphabet for the American Sign Language shown in FIG. 1. A representative translation table is shown in FIG. 3E. The pins of communications microcontroller 130, main microcontroller 140 and EEPROM 150 are connected as shown in FIG. 5A.

There is an eight line databus for eight data bits connected between communications microcontroller 130 and main microcontroller 140, with the lines being between pins 18 to 25 of both microcontrollers. The function of the various input and output pins of communications microcontroller 130 and main microcontroller 140 are shown in the table of FIG. 12.

Communications microcontroller 130 has 20 Mhz resonator 132 coupled thereto to drive its processor clock. The resonator is unpluggable allowing a computer (not shown) to be plugged in its place to drive the processor clock for embedded programming. HEXFET device 122 is coupled between the communications microcontroller and LCD display 120 with an 8 bit parallel interface 121, such as the 1 by 20 character display model 2011TNLDN0BN-TC manufactured by Vikay, to turn an LCD back light on/off at approximately 100 kHz. The display unit could be held, hung around the neck of a user, be mounted for standalone display.

Communication microcontroller 130 can include push-button controls, such one for backspace 131, and monitor lights 133. Similarly, main microcontroller 140 includes auto-translation button 137 whereby when pushed will do translation whenever hand movement is stopped, or to rest the hand to stop translations. Translate/screen clear button 139 is provided similar to that for the transmit controller. Back light button 141 is also provided to control the display back lighting.

Main microcontroller 140 also has a 20 Mhz resonator 143 coupled thereto to drive its processor clock. When main microcontroller 140 receives a message from communications microcontroller 130 to do a translation, it starts searching EEPROM 150 for the best translation. A computer links through a software UART into main microcontroller 140 whereby the data representative of the trained signs is uploaded into main microcontroller 140 which stores them into EEPROM 150. The data representative of the trained signs is stored as a symbol representing the trained sign and a reference hand position signal associated with the symbol as shown in FIG. 3E. Main microcontroller 140 also monitors the pushbutton controls, such as the LCD back light brightness control.

EEPROM 150 can store data representative of the 26 letters of the alphabet, along with hundreds of different hand gestures, for example, a position which is not a sign and can generate a “?”. Functional action symbols can be programmed in EEPROM 150, such as a hand sign command to “brighten the back light”. Various phrase data representations can be stored, for example, a hand sign command that will signify “Good Morning” which would be displayed when the corresponding hand sign motion is sensed.

The data, i.e., the binary numbers, from transmit subsystem 200 is received by receive subsystem 300. The data is inputted at pin 13 of communications microcontroller 130. The data input has 10 binary numbers representative of the letter that has been formed by the hand of the user. This data is transferred from communications microcontroller 130 to a main microcontroller 140 for a comparison with the data stored in the EEPROM 150 in the form of the translation table shown in FIG. 3E, wherein a sample of voltage values from each sensor are listed to identify what combination of sensor values are needed to represent the particular English character letter. After completion of the comparison of the data received and the data stored in the EEPROM 150 translation table and identification of the letter, this information is returned to communications microcontroller 130 for transmission to the display 120 for display of the identified letter. Communications microcontroller 130 has a backspace button 131 for use by the user of the glove to erase an incorrect letter that may appear on the display 120, with backspace button 131 coupled to pin 9 of communications microcontroller 130. The RTCC pin 2 of communications microcontroller 130 is not used and is left floating. The real time clock counter pin 2 of main microcontroller 140 is also not used and is left floating. The MCLR pins 28 of both communications microcontroller 130 and main microcomputer 140 are tied high to a plus 5 volts. The write-protect knot pin 3 of EEPROM 150 is also not used and is left floating. The serial receive pin 13 and serial transmit pin 12 are connected to a port 141 for communicating with a computer when setting up the system.

Referring now to FIG. 5B, the translated letters of the system appears on display 120. This display can be a standard liquid crystal display, such as a Vikay Model No.2011TNLDNOBN-TC. This display has large characters and a green back light that makes it easily readable. Display 120 has fourteen input pins, with the inputs cabled to a serial-to-parallel interface 121 between communications microcontroller 130 and display 120. A Trisys Serial Interface Module (SIM) is used for interface 121. The function of the fourteen input lines to display 120 are: eight data lines, a ground line, a plus 5-volt power line, a contrast line, a direction line, a write enable line, and a clock line. A back light power line is coupled from pin 11 of communications microcontroller 130 to display 120 through HEXFET 122. The liquid crystal display module has a format of 20 characters wide by 1 line high, and each character is 0.40″ tall. It also has a green back light, so that it can be read very well in the dark. It has an 8-bit parallel interface and three control lines, which will need to be driven by the receiver/translator circuit board. The biggest disadvantage to the display is that the back light uses LEDs, which require a total of about 300 ma of current at full brightness. Considering that the circuitry is optimized to be battery efficient, this is a big drain, because the rest of the circuitry draws approximately 55 milliamps. To help minimize the current draw of the back light, it is switched on and off by HEXFET 122 being pulse width modulated. Therefore, the back light is able to be dimmed down, by switching it on and off at a duty cycle between 0 and 100%, corresponding to a value of 0-255. To switch the back light on and off in the easiest manner, main microcontroller 140 will determine rather to switch it on or off every time the system clock resets, which is a high enough rate to eliminate flicker (about 78.4 KHz at 50% duty cycle). In other liquid crystal displays in accordance with an exemplary embodiment of the present invention, an electroluminescent back light is used to reduce power consumption. In addition to a visual display, a text to speech processor, such as the Winbond W75701 processor can be implemented with appropriate speaker hardware to convert the text data to natural sounding voice.

FIGS. 6A and 6B depict in block and schematic diagram form a computer interface that is employed when the data is sent over the airwaves from transmitter 60 to computer 412 for setting up the system for a new user or for training the person in the use of the glove to sign for letters. Voltage booster circuit 414 adjusts the voltage from receiver 416 to a level usable by computer 412.

When first using the glove, synchronization (training) is performed to distinguish signing characters unique to the individual performing the sign position. Computer 412 stores the trained characters in a training data base. Fine tuning, adding unique sign characters can then be performed. A portable translator can be plugged into the computer and the computer can off-load the training data base into character reference data memory 306, and in particular, re-writeable 8K byte EEPROM 150 on the portable translator.

When the system is being used for teaching a person in the proper position of the fingers and wrists of a hand for signing a letter of the alphabet, it is connected to a computer. The computer is coupled either by airwaves through the interface shown in FIGS. 6A, 6B or directly at the output pin 13 of transmitter microcontroller 50. A translation table, such as the one shown in FIG. 3E, is stored in the computer and comparisons with the output data from the A-D converter 20 is made in the computer with the information in the translation table. In this way, the user can modify the position of the fingers and wrists to view the character that is being signed and adjust the position of the fingers and wrist to desired character as viewed on the screen of the computer. This is a very effective teaching tool to teach people the proper sign for the letters of the alphabet.

Now turning to further microcontroller operation details, upon power up, the first task of main micro controller 140 is to read initialization data from the EEPROM that was stored when signs were transferred from the host PC to the receiver, and pass parts of it to communications microcontroller 130. The initialization data includes the initial brightness of the back light, the stability of the user's hand and fingers when held steady, the amount of time to do a translation after a steady hand position is reached, and how fast to repeat characters. Therefore, the receiver/translator device is very user-customizable, and it retains the settings while powered off.

Once all hardware has settled, I/O and internal registers are set up, and the initial device settings have been read into the microcontrollers from the EEPROM, the device is ready to start receiving data and doing translations. Main microcontroller 140 will go into an idle state, until it receives a packet from communications microcontroller 130. Communications microcontroller 130 is constantly receiving and retrieving data from the UART while the glove is running. Otherwise, it will also be in an idle state for 250 milliseconds at a time, at which point it wakes up to toggle the system heartbeat and reset the watchdog timer. When it's receiving data from the glove, it constantly dumps the data into a bank of registers, monitoring the readings to determine when the glove has become steady. When the glove has become steady for the user-determined period of time, communications microcontroller 130 transfers all nine sensor readings to main microcontroller 140, along with a message to tell it to do a translation. Main microcontroller 140 will then do the translation using the same algorithm as the host PC, using the EEPROM as the database storage medium. Once a translation is finished (usually about 175 microseconds), main microcontroller 140 transfers the printable character to communications microcontroller 130, along with a print command. Communications microcontroller 130 will then write the character to the LCD module, shifting all characters to the left one digit if the LCD is already full.

The other main functionality that the portable receiver/translator has is that it has the ability to receive information (initial setup and trained translation database) from the host computer, and store it in the EEPROM at logical locations. This is done by using a hardware cable to physically connect the portable receiver/translator the host PC. The software auto-detects the module, and gives the user choice of downloading the data to the device. When this option is selected, the host computer outputs all the data through the serial port, and main microcontroller 140 receives it. During the stop bit of each data packet, main microcontroller 140 looks up the correct address in the EEPROM, and stores the data at that location. This way, when a translation or power-up initialization is done, the data can be accessed. Since the EEPROM has 2000₁₆ storage locations, it can easily support the ASL finger spelling alphabet and any other special characters or numbers—with the current memory format, it has room for 465 characters. Currently, about 41 characters are used, which accounts for all letters, numbers (1-10), and special characters such as periods, exclamation points, and backspaces.

Transmitter microcontroller 50 on board the glove is needed to read the analog to digital converter, process the sensor levels, package the data, add cyclic redundancy checking, and to transmit this data over an RF link to the receiver. When the microcontroller powers up, initialization occurs first. Initialization includes setting up I/Os, allowing time for hardware to settle, initializing internal registers, initializing the software UART, and enabling interrupts. The CPU then enters an infinite loop, which simply reads the nine sensors multiple times, averaging the results, to ensure an accurate reading, packaging the results, adding a cyclic redundancy check (CRC), and transmitting the data out the software UART, into the RF transmitter. RF transmitter 60 runs in the bands of 315 MHz and 418 MHz, depending on the device. The buffer of the UART is never left empty—once the glove starts transmitting, it transmits non-stop until powered off. At this rate, the glove transmits just over 180 sensor readings and 18 battery readings per second.

Since the glove is simply a data acquisition system, it is the receiver's responsibility to track these readings, and translate them into text. The responsibilities of the software are to read the data from the serial port, do error correction, analyze the data, and handle it. If the received data is not correct (not all of it was received, or CRC failed), it is dropped, and the software waits for the next packet. Data that is not correct may be dropped, because the glove is transmitting constantly, so missing data segments can be rapidly replaced. Also, the RF link is a simplex communications mode, such that the host computer could request a packet to be re-sent. Once the host receives the data, it reads the packet header to determine what to do with the information. If it is a battery reading, the software displays the battery voltage level as a percentage on the graphics user interface (GUI), so that the user can see how much battery life is remaining. If the data is a sensor reading, the software updates the hand position on the GUI, and compares the reading with previous readings, to determine if the glove is currently moving. If the data has errors, the GUI updates the transmission accuracy meter, so that the user can see how clear the communications are between the glove and receiver. Lastly, if the software determines that the glove has been stable for a user-defined amount of time (usually 100-600 ms), it will do a translation of the current hand position.

To do a translation, the software refers to a database that was created when the user trained the glove. The software reads the first trained letter into memory, compares it to the current sensor readings, and determines the probability of it being the correct letter. The probability is determined by comparing the nine reference sensor readings that were trained into the database to the nine current sensor readings of the glove. Since each reading has a resolution of 8 bits, and there are 10 sensors, there are 255¹⁰, or about 1.16×10²⁴ possibilities. Therefore, the probability of a character being what the person is actually signing is between 10 and 1.16×10²⁴. To keep things scaled down, the software only uses a scale of 10 to 580,664, by doing a summation of the squared offset of each sensor reading from the stored reading in the database. The software then reads the next letter into memory, and determines the probability of it being the correct character, using the same process. If the next character has a higher probability of being correct, it will remove the first character from immediate memory, and add the second. Therefore, when the software finishes determining the probability of every letter in the alphabet, the most-likely letter is retained. This is the correct letter, so it is printed to the screen.

For an example of this process, say the first character in the database is an ‘A’, but the user is signing a ‘B’. The software will determine that the probability of an ‘A’ is somewhere around 198000/580644, meaning that there's only a 34.1% chance of the sign being an ‘A’. The software will then step to the next character, which in this case, would be a ‘B’. It may find that the probability of a ‘B’ is somewhere around 530708/580644, which is a 91.4% chance of ‘B’. The software will then drop ‘A’ out of memory, and replace it with ‘B’, since the sign is much more likely to be a ‘B’. The software will then load ‘C’ into memory from the database, and find its probability. It is much lower than ‘B’—most likely around 318774/580644, so 54.9%. Since ‘B’ is still more likely than A, the software will keep ‘B’ in memory, and unload ‘C’. The software will continue to do this, until it gets to the end of the database, at which point the ‘B’ will still be the character remaining in memory. Since ‘B ’ has then been determined to be the correct character, it will print a ‘B’ to the screen, and add it to the string of what the user is trying to say.

FIG. 7 is a block diagram depicting signal processing stages of a sign language translator in accordance with an exemplary embodiment of the present invention. A previously described transmitter microcontroller 50 attached to a previously described glove (not shown) initializes (700) itself when power is applied to transmitter microcontroller 50. Transmitter microcontroller 50 then reads (702) sensor signals from the previously described bend sensors and transmits (704) the combined sensor signals as a hand position signal 705 to previously described communications microcontroller 130 located in a previously described display device.

Communications microcontroller 130 receives (706) and stores the hand position signal and then determines (708) if the hand position signal has stabilized in time. In a communications microcontroller in accordance with an exemplary embodiment of the present invention, stabilization is determined by comparing successive hand position signals. If two successive hand position signals are substantially the same, then the hand position signal is determined to be stabilized. If the hand position signal has not stabilized, communications microcontroller 130 receives and stores (706) another hand position signal. If the hand position signal is stabilized, communications microcontroller 130 transmits the most recent hand position signal 712 to previously described main microcontroller 140.

Main microcontroller 140 receives and translates (714) the hand position signal into a symbol 717 that is transmitted (716) back to communications microcontroller 130 which transmits the symbol to another device for output. As previously described, an output device may be an LCD display or a text-to-speech convertor.

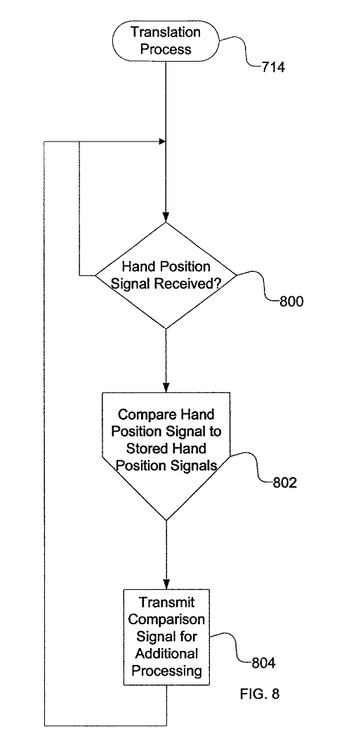

FIG. 8 is a process flow diagram of a translation process as used by a main microcontroller in accordance with an exemplary embodiment of the present invention. The main microcontroller, such as main microcontroller 140 (FIG. 7), initiates a translation process 714 when it determines it has received (800) a hand position signal from previously described communications microcontroller 130 (FIG. 7). Main microcontroller 140 determines a matched symbol corresponding to the received hand position signal by comparing (802) the received hand position signal to reference hand position signals associated with symbols stored in memory in a to-be-described process. Main microcontroller 140 then transmits a comparison signal corresponding to the matched symbol to the communications microcontroller 130 for retransmission to an output device.

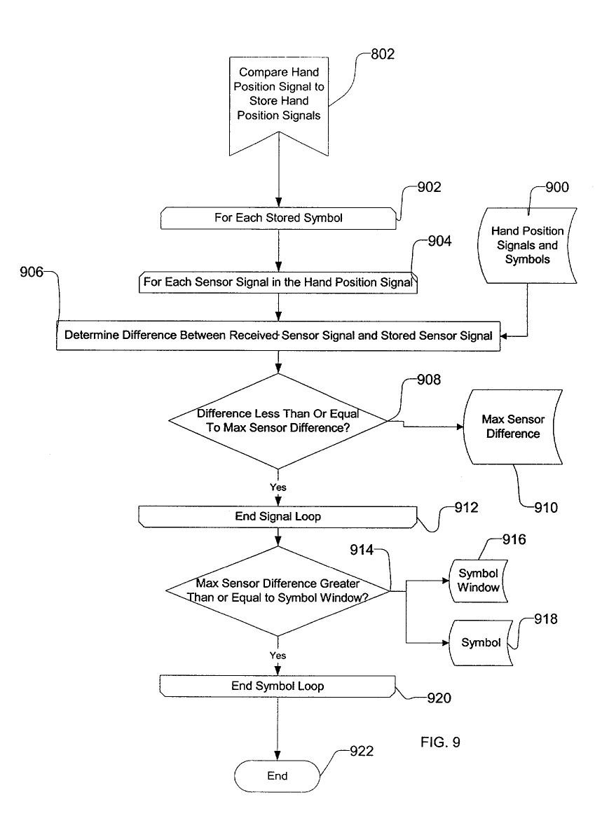

FIG. 9 is a flow diagram of a comparison process as used by a main microcontroller in accordance with an exemplary embodiment of the present invention. In a comparison process 802, a main microcontroller, such as main microcontroller 140 (FIG. 7), uses previously described stored associations of hand position signals and symbols 900. For each stored symbol (902) and for each reference sensor signal (904) in the symbol's associated reference hand position signal, main microcontroller 140 determines (904) the absolute value of the difference between the reference sensor signal and the received hand position signal's corresponding sensor signal. Main microcontroller 140 determines (908) if the difference is less than or equal to a stored max sensor difference 910. If the difference is greater than the stored max sensor difference, then main microcontroller replaces the max sensor difference with the difference. Main microcontroller continues processing sensor signals until all of the sensor signals are processed for a symbol's associated reference hand position signal 912. The resultant stored max sensor difference is then a measure of the similarity of a symbol's stored hand position signal and the received hand position signal. This measure of similarity between the hand position signals is herein termed a “difference window”. The smaller the difference window, the more similar a symbol's associated reference hand position signal is to a received hand position signal.

Once main microcontroller 140 determines a difference window for a symbol, main microcontroller 140 compares (914) the symbol's difference window to a stored symbol difference window 916. If the symbol's difference window is smaller than the stored symbol difference window, then the stored symbol difference window is replaced with the symbol's difference window and the symbol is stored 918 as the symbol whose associated reference hand position signal best matches the received hand position signal. Main microcontroller continues (920) processing symbols until all the stored symbols' associated reference hand position signals are compared to the received hand position signal. At the end of the process, the stored symbol is the symbol whose associated reference hand position signal is the best match to the received hand position signal. The main microcontroller then continues (922) the translation process as shown in FIG. 8.

In a hand position signal comparison and symbol determination process in accordance with an exemplary embodiment of the present invention, the differences between sensor values is summed to determine the size of a difference window. In another embodiment, the differences are manipulated, for example by raising the difference to a specified power such as squaring, in order to emphasize the contribution from a single large sensor difference.

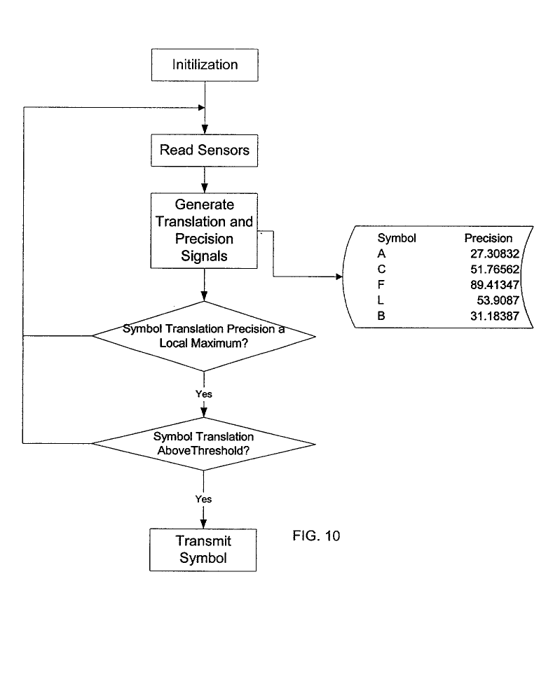

FIG. 10 is a flow diagram of a translation process as used by a microcontroller in accordance with another exemplary embodiment of the present invention. In the illustrated translation process, the microcontroller reads (1000) previously described bend sensors to generate a hand position signal. The microcontroller generates (1002) a hand position signal to symbol translation each time the microcontroller reads the sensors. The translated symbol and a precision value are stored in a translation symbol and precision array 1010. The precision of a translation of a hand position signal into a symbol is indicated by the precision value, the more precise the translation, the higher the precision value.

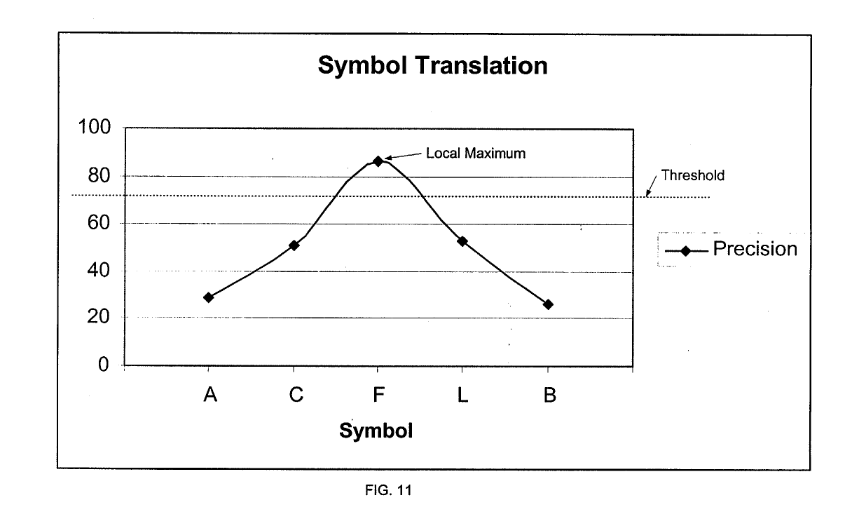

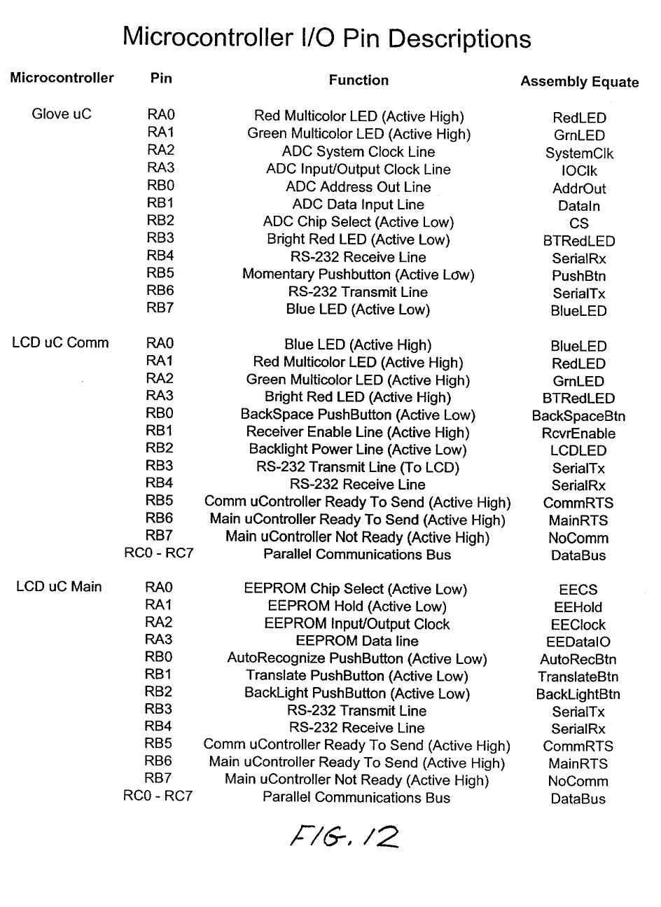

FIG. 11 is a graph of precision values versus translation symbols as shown in array 1010 of FIG. 10. On the precision value graph 1100, precision values are plotted along the Y-axis 1102 versus translation symbols plotted along the X-axis 1104. A line 1106 drawn through the precision values indicates that a local maximum 1108 is reached for symbol F 1110.

Referring again to FIG. 10, the microcontroller uses the translation symbol and precision array to determine if a translated symbol is at a local maximum as indicated by the translated symbol's precision value. An exemplary algorithm for determination of a local maximum when there are 5 values in the translation symbol and precision value array is as follows: if a current translation is less precise than the previous translation, which is less precise than the translation before, which is more precise than the two previous translations, then the translation from the two instances before the current translation is chosen as a local maximum. In the translation symbol and precision value array shown, the local maximum determined from the preceding algorithm would be the symbol “F”. If the microcontroller determines that there is no local maximum, the microcontroller continues by reading 1000 the bend sensors as previously described.

Referring again to FIG. 11, a hand position signal to symbol translation process may also use a threshold value to aid in determination of a hand position signal to symbol translation. In the graphed example, a threshold value, as indicated by line 1112, is the minimum precision value that a translation symbol should have in order to be considered as a correct translation.

Referring again to FIG. 10, the microcontroller determines if the precision value of a translation symbol identified at a local maximum is above a threshold value. If the precision value is not above the threshold value, the microcontroller continues by reading (1000) the bend sensors. If the precision value is above the threshold value, then the microcontroller transmits the translation symbol at the local maximum as a comparison signal for further output processing such as display as a character or output as speech as previously described.

Although this invention has been described in certain specific embodiments, many additional modifications and variations would be apparent to those skilled in the art. Those skilled in the art can appreciate: that the receiver components can be integrated into a single chip configuration having an integral microcontroller, transceiver, and voltage; the microcontroller can have a 12 bit ADC and flash memory built into the microcontroller chip, such as a Texas Instruments MSP430 Mixed Signal Microcontroller; the transmitter controller can include push-button control, such identifying that a hand-sign is for training input, or extended holding for clearing the screen; two hand sensors can be combined and multiplexed such that combinations of the two hand sign movements can represent various symbols, phrases or commands; and that the described sign language translator can be used as a generic input device for translation of hand positions into any type of symbols. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents.

What is claimed is:

1. A hand sign language translator apparatus comprising:
a transmit subsystem having:
a sign language sensor processing subsystem, the sign language sensor processing subsystem generating a hand position signal in response to a hand position; and
a transmitter for transmitting the hand position signal; and
a remote receive subsystem, having:
a receiver for receiving a transmitted hand position signal;
a memory for storing a plurality of symbols, each symbol associated with a reference hand position signal; and
a processing subsystem for generating a comparison signal representative of a symbol by matching the hand position signal to a reference hand position signal associated with the symbol and outputting the symbol as represented by the hand position and processing the comparison signal for output of the symbol as represented by the hand position.

2. The hand sign language translator apparatus of claim 1, wherein:
the sign language sensor processing subsystem includes a plurality of voltage dividing sensors adapted for mounting on a hand, each voltage dividing sensor being driven by a voltage source and providing a respective sensor signal in response to a hand position, each sensor signal being combined to form the hand position signal; and
the stored reference hand position signal includes reference sensor signals corresponding to the sensor signals in the hand position signal.

3. The hand sign language translator apparatus of claim 2, wherein the plurality of voltage dividing sensors are adapted for mounting along selected finger, palm, wrist and finger gaps of the hand.

4. The hand sign language translator apparatus of claim 2, wherein the voltage dividing sensors are each a flexible sensor whose resistance value changes when bent.

5. The hand sign language translator apparatus of claim 1, wherein the transmit subystem includes:
an analog to digital converter for converting the hand position signal from an analog hand position signal to a digital hand position signal; and
wherein the transmitter is a radio frequency transmitter for transmitting the digital hand position signal.

6. The hand sign language translator apparatus of claim 1, wherein the memory stores a reference hand position signal associated with a training symbol, the reference hand position signal being representative of a particular user hand position, the user hand position being formed by a particular user in response to the training symbol.

7. The hand sign language translator apparatus of claim 2, wherein the processing subsystem includes means for generating a difference window for each reference hand position signal using the sensor signals in the hand position signal and the corresponding reference sensor signals in the reference hand position signal and for selecting as a match the reference hand position signal having a smallest difference window.

8. The hand sign language translator apparatus of claim 7, wherein the difference window is generated from differences in values between the sensor signals and the corresponding reference sensor signals.

9. The hand sign language translator apparatus of claim 7, wherein the difference window is generated from summing the differences in values between the sensor signals and the corresponding reference sensor signals.

10. The hand sign language translator apparatus of claim 7, wherein the difference window is generated from summing the differences in values between the sensor signals and the corresponding reference sensor signals raised to a specified power.

11. The hand sign language translator apparatus of claim 1, wherein the processing subsystem includes means for generating a plurality of translation symbols and corresponding precision values for a series of hand position signals and for selecting a translation symbol using the plurality of translation symbols and corresponding precision values.

12. The hand sign language translator apparatus of claim 11, wherein the processing subsystem further includes means for selecting a translation symbol from the plurality of translation symbols having a local maximum in precision as determined from the plurality of precision values.

13. The hand sign language translator apparatus of claim 12, wherein the processing subsystem further includes means for selecting a translation symbol whose corresponding precision value exceeds a specified threshold.

14. The hand sign language translator apparatus of claim 1, wherein the receiver receives the hand position signal transmitted by the transmit subsystem and the processing subsystem compares the hand position signal with the reference hand position signals.

15. The hand sign language translator apparatus of claim 1, wherein the remote receive subsystem is portable.

16. The hand sign language translator apparatus of claim 1, wherein the processing subsystem includes a visual symbol display device responsive to the comparison signal for output of the symbol that the hand position represents.

17. The hand sign language translator apparatus of claim 16, wherein the visual symbol display device is a liquid crystal display.

18. The hand sign language translator apparatus of claim 1, wherein the processing subsystem includes means for converting the comparison signal to an audible sound representative of the symbol.

19. The hand sign language translator apparatus of claim 1, wherein each symbol can be selected from alphabet letters, punctuation, symbols and phrases.

20. A method of translating hand sign language positions into symbols comprising:
providing a sign language sensor, the sign language sensor generating a hand position signal in response to a hand position;
transmitting the hand position signal by a transmit system to a remote receive subsystem;
receiving a transmitted hand position signal by the remote receive subsystem;
storing in memory a plurality of symbols, each symbol associated with a reference hand position signal;
generating a comparison signal representative of a symbol by matching the transmitted hand position signal to a reference hand position signal associated with the symbol; and
processing the comparison signal for output of the symbol as represented by the hand position.

21. The method of claim 20,:
wherein providing a sign language sensor includes adapting for mounting a plurality of voltage dividing sensors on a hand, each voltage dividing sensor being driven by a voltage source and providing a respective sensor signal in response to a hand position, each sensor signal being combined to form the hand position signal; and
wherein a stored reference hand position signal includes reference sensor signals corresponding to the sensor signals in the hand position signal.

22. The method of claim 21, further comprising adapting for mounting the plurality of voltage dividing sensors along selected finger, palm, wrist and finger gaps of the hand.

23. The method of claim 21, wherein the voltage dividing sensors are each a flexible sensor whose resistance value changes when bent.

24. The method of claim 20, wherein transmitting the hand position signal to a remote receive subsystem includes:
converting the hand position signal from an analog hand position signal to a digital hand position signal; and
radio frequency transmitting the digital hand position signal.

25. The method of claim 20, wherein the storing in memory of the plurality of symbols associated with reference hand position signals includes:
determining a reference hand position signal representative of a particular user hand position, the user hand position being formed by the particular user in response to a training symbol; and
storing in the memory the reference hand position signal associated with the training symbol.

26. The method of claim 21, wherein matching the hand position signal to a reference hand position signal includes:
generating a difference window for each reference hand position signal using the sensor signals in the hand position signal and the corresponding reference sensor signals in the reference hand position signal; and
selecting as a match the reference hand position signal having a smallest difference window.

27. The method of claim 26, wherein the difference window is generated from differences in values between the sensor signals and the corresponding reference sensor signals.

28. The method of claim 26, wherein the difference window is generated from summing the differences in values between the sensor signals and the corresponding reference sensor signals.

29. The method of claim 26, wherein the difference window is generated from summing the differences in values between the sensor signals and the corresponding reference sensor signals raised to a specified power.

30. The method of claim 20, wherein matching the hand position signal to a reference hand position signal includes:
generating a plurality of translation symbols and corresponding precision values for a series of hand position signals; and
selecting a translation symbol using the plurality of translation symbols and corresponding precision values.

31. The method of claim 30, further including selecting a translation symbol from the plurality of translation symbols having a local maximum in precision as determined from the plurality of precision values.

32. The method of claim 31, further including selecting a translation symbol whose corresponding precision value exceeds a specified threshold.

33. The method of claim 20, further comprising receiving the hand position signal transmitted by the transmit system by the remote receive subsystem and comparing at the remote receive subsystem the hand position signal with the reference hand position signals.

34. The method of claim 20, wherein the remote receive subsystem is portable.

35. The method of claim 20, wherein the processing the comparison signal for output of the symbol that the hand position represents includes visually displaying the symbol on a display device.

36. The method of claim 33, wherein the display device is a liquid crystal display.

37. The method of claim 20, wherein the processing the comparison signal for display of the symbol that the hand position represents includes converting the comparison signal to an audible sound representative of the symbol.

38. The method of claim 20, wherein each symbol can be selected from alphabet letters, punctuation, symbols and phrases.

39. A sign language sensor comprising:
a plurality of voltage dividing sensors, each voltage dividing sensor being respectively adapted for mounting along selected finger, palm and finger gap locations of a hand; and
a voltage source coupled to each voltage dividing sensor being driven;
each respective voltage dividing sensor providing a divided output signal in response to each hand element position, each respective hand element voltage divided output signal being combinable to form a hand position signal representative of a sign language symbol;
wherein the voltage dividing sensors are flexible sensors whose resistance values change when bent; and
wherein the voltage dividing sensors are mounted on a glove worn on a hand that provides the hand position signal.
